(19) United States
(12) Patent Application Publication
(10) Pub. No.: US 2023/0085385 A1
(43) Pub. Date: Mar. 16, 2023

(54) OPTICAL DEVICE

(71) Applicant: Panasonic Intellectual Property Management Co., Ltd., Osaka (JP)

(72) Inventors: Satoshi KUZUHARA, Osaka (JP); Tsuneo UCHIDA, Chiba (JP)

(21) Appl. No.: 17/988,968

(22) Filed: Nov. 17, 2022

Related U.S. Application Data
(63) Continuation of application No. PCT/JP2020/044344, filed on Nov. 27, 2020.

(30) Foreign Application Priority Data
May 19, 2020 (JP) 2020-087487

(51) Int. Cl. G02B 26/10; G02B 17/08

(52) U.S. Cl. CPC G02B 26/101; G02B 17/086

(57) ABSTRACT

An optical device includes a lens element, a first scanning element, and a controller. The lens element directs first light emitted from the first light-emitting element and second light emitted from the second light-emitting element, to a predetermined position. The first scanning element is arranged at the predetermined position, on which first light and second light exiting the lens element are incident at mutually different angles. The controller provides light emission control to start light emission at light emission timings shifted. The first light-emitting element and the second light-emitting element is arrayed such that an optical axis of first light and an optical axis of second light are contained in a same plane. The controller controlees the light emission timings of the first light-emitting element and the second light-emitting element in response to rotation actions of the first scanning element.

### CROSS-REFERENCE TO RELATED APPLICATIONS

This is a continuation application of International Application No. PCT/JP2020/044344, with an international filing date of Nov. 27, 2020, which claims priority of Japanese Patent Application No. 2020-87487 filed on May 19, 2020, the content of which is incorporated herein by reference.

### BACKGROUND OF THE INVENTION

### 1. Technical Field

The present disclosure relates to an optical device combining a plurality of light.

### 2. Description of the Related Art

JP 2018-108400 A discloses an optical system having a scanner that scans laser light in two directions. This optical system is described as transmitting scanned laser light by use of a mirror. One light is transmitted from a light source.

In JP 2018-108400 A, however, one light source is described, and in the case of combining light from a plurality of light sources, a combining element is needed.

For example, the optical system needs to include the combining element such as a dichroic mirror, which causes a problem of upsized optical system.

### SUMMARY

The present disclosure provides an optical device that suppresses upsizing of the optical system and that combines light from a plurality of light sources.

The optical device of the present disclosure comprises: a light-emitting element group that includes a first light-emitting element and a second light-emitting element; a lens element that directs first light emitted from the first light-emitting element and second light emitted from the second light-emitting element, to a predetermined position; a first scanning element arranged at the predetermined position, on which first light and second light exiting the lens element are incident at mutually different angles; and a controller that controls light emission by differentiating light emission timings of the first light-emitting element and the second light-emitting element, the first light-emitting element and the second light-emitting element being arrayed such that an optical axis of first light and an optical axis of second light are contained in a same plane, the first scanning element having a scanning axis that extends in a direction orthogonal to the plane, the first scanning element rotating around the first scanning axis, the controller controlling the light emission timings of the first light-emitting element and the second light-emitting element in response to rotation of the first scanning element so that first light and second light are each reflected in a same direction by the first scanning element.

According to the optical device of the present disclosure, it is possible to suppress upsizing of the optical system as well as to combine light from a plurality of light sources.

### BRIEF DESCRIPTION OF THE DRAWINGS

FIG. 1 is a sectional view showing a configuration of an optical device of a first embodiment;

FIG. 2 is an explanatory view explaining drawing positions on a projection surface and light emission timings of light-emitting elements;

FIG. 3 is an explanatory view showing a positional relationship between a lens element and the light-emitting elements;

FIG. 4 is an explanatory view showing a light emission timing of the light-emitting elements and a rotation action of a first scanning element;

FIG. 5 is an explanatory view showing a light emission timing of the light-emitting elements and a rotation action of the first scanning element;

FIG. 6 is an explanatory view showing a light emission timing of the light-emitting elements and a rotation action of the first scanning element;

FIG. 7 is a configuration diagram showing a variant of the lens element;

FIG. 8A is a sectional view showing a configuration of an optical device of a second embodiment;

FIG. 8B is an explanatory view showing an arrangement of the light-emitting elements;

FIG. 9 is an explanatory view showing a light emission timing of the light-emitting elements and a rotation action of a first scanning element;

FIG. 10 is an explanatory view showing a light emission timing of the light-emitting elements and a rotation action of the first scanning element; and

FIG. 11 is an explanatory view showing a light emission timing of the light-emitting elements and a rotation action of the first scanning element.

### DETAILED DESCRIPTION

Embodiments will be described in detail below with proper reference to the drawings. In some cases, however, more detailed description than necessary may be omitted. For example, detailed description of already well-known matters or duplicate description for substantially the same configuration may be omitted. This is to avoid the following description from becoming unnecessarily redundant, to facilitate the understanding of those skilled in the art.

It is to be noted that the inventor(s) provides the accompanying drawings and the following description for those skilled in the art to fully understand the present disclosure, and that it is not intended to limit thereby the subject matter described in the claims.

### First Embodiment

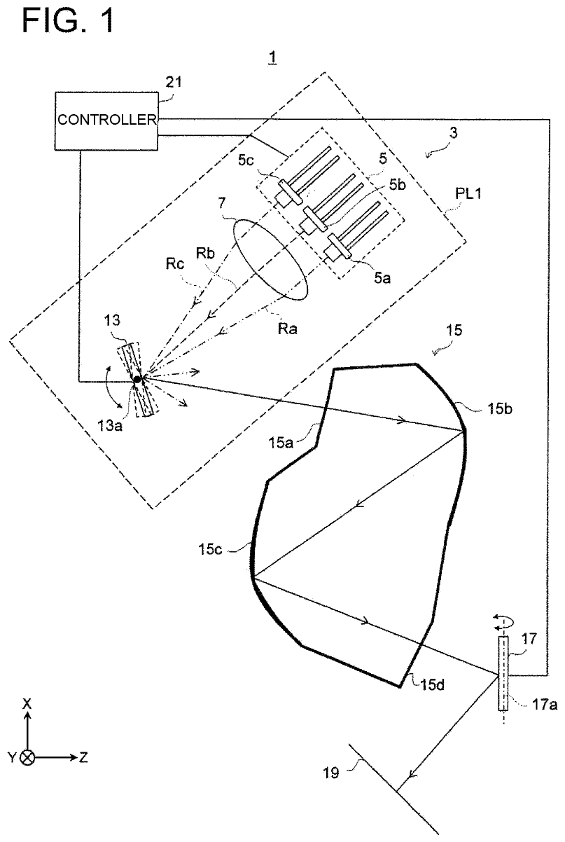

A first embodiment will now be described with reference to FIGS. 1 to 6. In this embodiment, as shown in FIG. 1, for example, X-direction is a direction of a scanning axis 17a around which a second scanning element 17 rotates. Y-direction is a direction of a scanning axis 13a around which a first scanning element 13 rotates. Z-direction is a direction orthogonal to an X-Y plane. X-, Y-, and Z-directions are mutually orthogonal to one another. The first scanning element 13 and the second scanning element 17 rotate, for example, about ±10° periodically around their respective scanning axes 13a and 17a.

### [1-1. Configuration]

FIG. 1 is a configuration diagram showing a configuration of an optical device 1 according to the present disclosure. The optical device 1 comprises an optical system 3 and a controller 21. The optical system 3 comprises a light-emitting element group 5, a lens element 7, the first scanning element 13, a prism 15, and the second scanning element 17.

The light-emitting element group 5 includes, as a light source, two or more light-emitting elements with different colors. The light-emitting element is, for example, a semiconductor laser. In the first embodiment, the light-emitting element group 5 includes a light-emitting element 5a emitting a red light Ra, a light-emitting element 5b emitting a green light Rb, and a light-emitting element 5c emitting a blue light Rc. In this manner, light Ra, Rb, and Rc are, for example, laser light and differ in color due to their respective different wavelength peaks. When collectively referring to light Ra, Rb, and Rc, they will be described as light R.

The light-emitting elements 5a, 5b, and 5c are arrayed such that a plane PL1 contains optical axes of light Ra of the light-emitting element 5a, light Rb of the light-emitting element 5b, and light Rc of the light-emitting element 5c. The light-emitting elements 5a, 5b, and 5c may be arranged offset in a direction along the optical axes as long as they lie in the plane PL1. In FIG. 1, the plane PL1 is an X-Z plane. As shown in FIG. 1, when the first scanning element 13 lies at a position indicated by a solid line, the angle formed between the optical axis of light heading for the first scanning element 13 from each of the light-emitting elements and the optical axis of light heading for the prism 15 from the first scanning element 13 is greater in order of light-emitting elements 5c, 5b, and 5a.

The lens element 7 directs each light emitted from the light-emitting element group 5 to a predetermined position that is a focal position. A center of the first scanning element 13 is arranged at the predetermined position. The lens element 7 is, for example, a collimating lens. The lens element 7 is arranged such that a center line of the lens element 7 passing through a center of the lens element 7 and perpendicular to a lens surface lies, for example, on the optical axis of the light-emitting element 5b.

The first scanning element 13 scans incident light, in the plane PL1, around the scanning axis 13a orthogonal to the plane PL1. The first scanning element 13 scans incident light, for example, in X-direction as a first direction. The first scanning element 13 is, for example, a mirror that is rotationally driven by piezoelectric drive with the rotation axis (scanning axis 13a) extending in Y-direction. The first scanning element 13 is, for example, a vertical scanner. This allows light reflected by the first scanning element 13 to diffuse in X-direction.

The prism 15 is one form of a relay optical system that, on an optical path from the first scanning element 13 to the second scanning element 17, collects light R scanned by the first scanning element 13 onto the second scanning element 17. The prism 15 has an incident surface 15a and an exit surface 15d, and further has one or more reflection surfaces on an optical path from the incident surface 15a to the exit surface 15d. In this embodiment, the prism 15 has a first reflection surface 15b and a second reflection surface 15c. The incident surface 15a and the exit surface 15d are of a flat shape, a convex shape, or a concave shape. The prism 15 is made of, for example, resin or glass. Although the relay optical system may be composed of a plurality of reflection mirrors, adoption of a prism as the relay optical system can reduce the size of the relay optical system.

The incident surface 15a faces the first scanning element 13 so that light R scanned in X-direction by the first scanning element 13 enters the prism 15 through the incident surface 15a. The incident surface 15a and the first reflection surface 15b confront each other so that light incident from the incident surface 15a is reflected into the interior of the prism 15 by the first reflection surface 15b.

Light reflected by the first reflection surface 15b is again reflected into the interior of the prism 15 by the second reflection surface 15c arranged facing the exit surface 15d. Light reflected by the second reflection surface 15c advances to the exit surface 15d to exit the prism 15 through the exit surface 15d.

The first reflection surface 15b and the second reflection surface 15c each have a concave shape with respect to incident light.

The second scanning element 17 scans light leaving the prism 15 in Y-direction to project it onto a projection surface 19. The second scanning element 17 is, for example, a mirror that is rotationally driven by piezoelectric drive with the rotation axis extending in X-direction. The second scanning element 17 is, for example, a horizontal scanner. The second scanning element 17 performs scanning in synchronism with the first scanning element 13 so that a two-dimensional image can be projected onto the projection surface 19.

The optical device 1 of this embodiment includes, arranged in the mentioned order from the light-emitting element group 5 on the optical path, the lens element 7, the first scanning element 13, the incident surface 15a of the prism 15, the first reflection surface 15b of the prism 15, the second reflection surface 15c of the prism 15, the exit surface 15d of the prism 15, and the second scanning element 17. The prism 15 is therefore arranged on the optical path from the first scanning element 13 to the second scanning element 17.

The controller 21 controls the emission timings of light Ra, Rb, and Rc of each color, in synchronism with the scanning timing of the first scanning element 13 and the second scanning element 17. The light-emitting elements 5a, 5b, and 5c emit in sequence, with different timings, light Ra, Rb, and Rc of red, green, and blue luminous fluxes in accordance with control signals from the controller 21. Time to shift the timing is sufficiently smaller than the rotation period of the first scanning element 13, which is the level at which the user does not notice the timing shift.

The controller 21 can be implemented by a semiconductor element, etc. The controller 21 can be composed of, for example, a microcomputer, a CPU, an MPU, a GPU, a DSP, an FPGA, or an ASIC. Functions of the controller 21 may be composed of only hardware, or may be implemented by combining hardware and software together. The controller 21 includes a storage such as a hard disc (HDD), an SSD, or a memory, and reads data or programs stored in the storage to perform various arithmetic processes to thereby implement the predetermined functions.

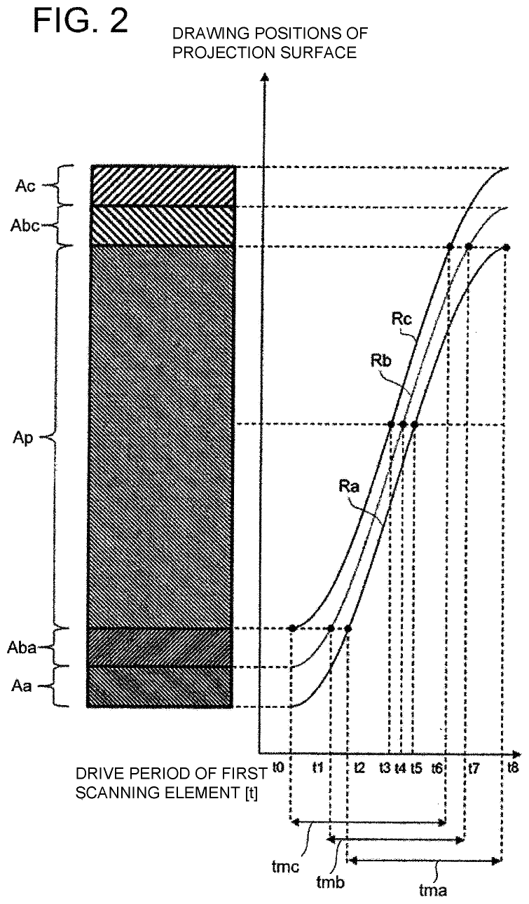

As shown in FIG. 2, the drive period of the first scanning element 13 and the light emission timing of each light-emitting element are adjusted. Used as “drawing area Ap” on the projection surface 19 is a scanning area in which the blue, green, and red light Rc, Rb, and Ra can be combined. “Red area Aa” is an area where only the red light Ra can be scanned, and “green+red area Aba” is an area where only the red light Ra and green light Rb can be scanned. “Blue area Ac” is an area where only the blue light can be scanned, and “green+blue area Abc” is an area where only the blue light Rc and green light Rb can be scanned. The first scanning element 13 is driven by the controller 21 with one period being time from t0 through t8 back to t0. Hence: the drawing area Ap can display a picture in which the blue, green, and red light are combined; the red area Aa can display only a red picture; and “green+red” area Aba can display a picture in which the green and red light are combined. The blue area Ac can display only a blue picture, and the green+blue area Abc can display a picture in which the green and blue light are combined.

The first scanning element 13 rotates, for example, with a period of −π/2 to +π/2, and has a maximum amount of rotation in a negative direction at t0 and a maximum amount of rotation in a positive direction at t8. As regards the drive period capable of combining color light: light emission timings tmc of the blue light Rc are t0 to t6; light emission timings tmb of the green light Rb are t1 to t7, and light emission timings tma of the red light Ra are t2 to t8.

Even though the light-emitting elements 5a to 5c are caused to emit light at the same timing, their respective light Ra, Rb, and Rc are reflected in different directions due to different incident angles of light Ra, Rb, and Rc on the first scanning element 13. Thus, to cause light Ra, Rb, and Rc to reflect in the same direction, the light emission timings of the light-emitting elements 5a to 5c need to be shifted from each other.

For example, the light emission timing of the green light Rb in the light-emitting element 5b allowing reflection in the same direction as that of the blue light Rc emitted from the light-emitting element 5c at the timing of t0 is t1, and the light emission timing of the red light Ra in the light-emitting element 5a is t2. These timings are timings at one end that allow the blue, green, and red light Rc, Rb, and Ra to be combined.

The light emission timing of the green light Rb in the light-emitting element 5b allowing reflection in the same direction as that of the red light Ra emitted from the light-emitting element 5a at the timing of t8 is t7, and the light emission timing of the blue light Rc in the light-emitting element 5c is t6. These timings are timings at the other end that allow the blue, green, and red light Rc, Rb, and Ra to be combined.

Accordingly, the light-emitting elements 5a to 5c emit light at their respective timings allowing combining of light so that light Ra, Rb, and Rc are each reflected in the same direction with time differences by the first scanning element 13, whereby they are apparently combined. Light Ra, Rb, and Rc reflected in the same direction travel through the interior of the prism 15 and are scanned by the second scanning element 17 to impinge at the same position on the projection surface 19. As used herein, the same direction involves a directional misalignment perceivable as being combined when light projected onto the projection surface 19 are viewed by a person.

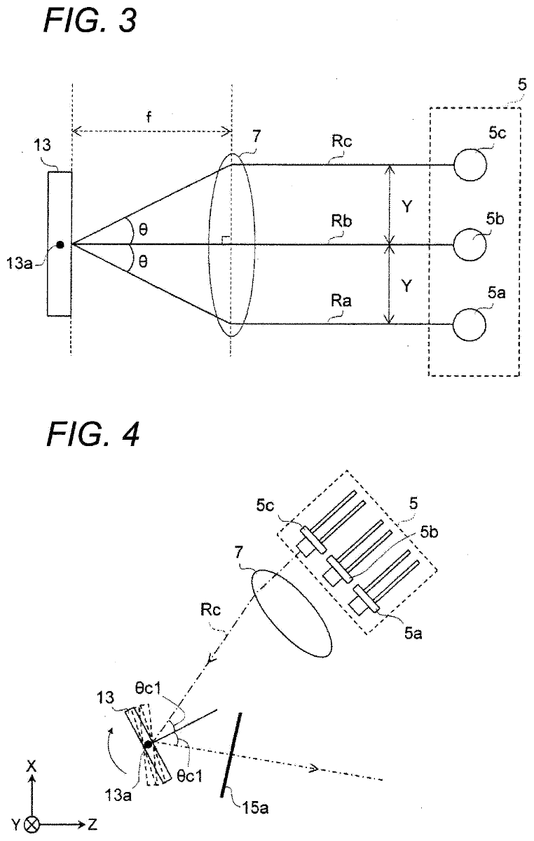

As shown in FIG. 3, the light-emitting elements 5a to 5c are arranged such that a length Y between the light-emitting elements 5a and 5b is equal to a length Y between the light-emitting elements 5b and 5c, and a focal length f of the lens element 7, the length Y between the adjacent light-emitting elements 5a to 5c, and an angle θ between the optical axes of light irradiated from the adjacent light-emitting elements 5a to 5c may satisfy the condition of the following formula.

θ=|arctan(Y/f)·180/π|<10° (1)

Note that in cases where a distortion aberration occurs in the lens element 7, θ of Formula (1) is an approximate value.

By allowing the focal length f of the lens element 7 and the length Y between the light-emitting elements 5a to 5c to satisfy Formula (1), the first scanning element 13 can have a suppressed maximum scanning angle.

Referring then to FIGS. 4 to 6, description will be given of light-emitting actions of the light-emitting element group 5 and scanning of the first scanning element 13, performed when correcting the incident angle onto the projection surface 19.

As shown in FIG. 4, for example, the light-emitting element 5c emits light at the timing of t3 so that the blue light Rc falls on the first scanning element 13 with an incident angle θc1 as a third incident angle and reflects with a reflected angle θc1 to head for the incident surface 15a.

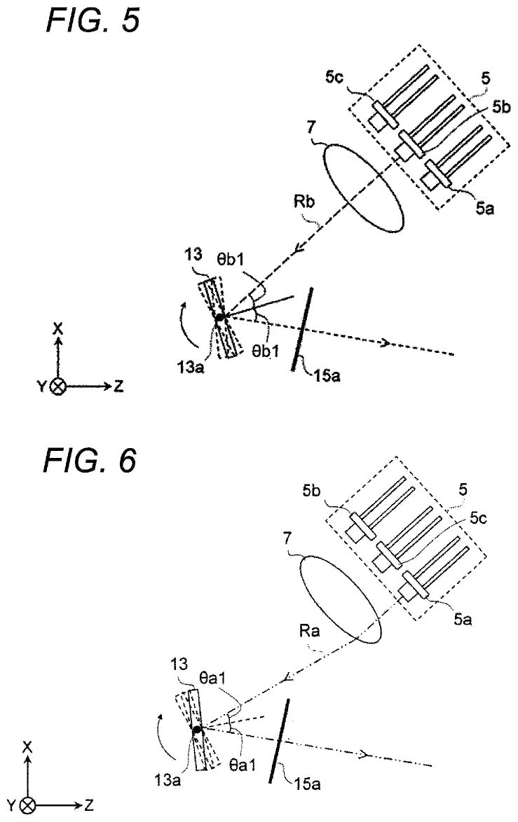

Next, as shown in FIG. 5, the first scanning element 13 rotates clockwise and the light-emitting element 5b emits light at the timing of t4 so that the green light Rb falls on the first scanning element 13 with an incident angle θb1 as a second incident angle and reflects with a reflected angle θb1 to head for the incident surface 15a in the same direction as the direction of reflection of the blue light Rc.

Next, as shown in FIG. 6, the first scanning element 13 further rotates clockwise and the light-emitting element 5a emits light at the timing of t5 so that the red light Ra falls on the first scanning element 13 with an incident angle θa1 as a first incident angle and reflects with a reflected angle θa1 to head for the incident surface 15a in the same direction as the direction of reflection of the blue light Rc and the green light Rb. In this manner, the blue light Rc, the green light Rb, and the red light Ra can be combined. The relationship among the incident angles θa1 to θc1 is θa1<θb1<θc1. In cases where, as shown in FIG. 3, the light-emitting element 5b is arranged on the center line of the lens element 7 between the light-emitting elements 5a and 5c, with the light-emitting elements 5a and 5c being arranged symmetrically with respect to the center line of the lens element 7, the relationship is ideally |θc1−θb1|=|θb1−θa1|=θ/2. For example, by keeping the shifts within 1′, the projected light can be recognized as being combined when viewed by a person.

When the first scanning element 13 rotates counterclockwise, the red light Ra, the green light Rb, and the blue light Rc are sequentially emitted in the mentioned order, with the result that light can be combined.

In this manner, by shifting the light emission timings of the blue light-emitting element 5c and the red light-emitting element 5a with respect to the light emission timing of the green light-emitting element 5b so that their respective incident angles and reflected angles on the first scanning element 13 differ, light Ra, Rb, and Rc can reflect in the same direction, whereupon light Ra, Rb, and Rc can be combined.

Although in FIG. 3 the light-emitting elements 5a, 5b, and 5c are arranged at equi-intervals for ease of explanation, they may be arrayed at their respective different intervals.

Although in FIGS. 4 to 6, the incident angles between the light-emitting element group 5 and the first scanning element 13 when correcting the incident angles at predetermined positions on the projection surface 19 are designated by θa1, θb1, and θc1, the incident angles θa1, θb1, and θc1 vary depending on the predetermined positions on the projection surface 19.

### [1-2. Effects, etc.]

The optical device 1 of the first embodiment comprises the light-emitting element group 5 that includes the light-emitting element 5a and the light-emitting element 5b, and the lens element 7 that condenses red light Ra emitted from the light-emitting element 5a and the green light Rb emitted from the light-emitting element 5b at a predetermined position. The optical device 1 comprises the first scanning element 13, arranged at a given position, on which light Ra and Rb leaving the lens element 7 strike with their respective different angles, and the controller 21 that controls light emission by differentiating light emission timings of the light-emitting element 5a and the light-emitting element 5b. The light-emitting elements 5a and 5b are arrayed such that the optical axes of light Ra and Rb are contained in the same plane PL1. The first scanning element 13 has the scanning axis 13a extending in the direction orthogonal to the plane PL1 and rotates around the scanning axis 13a. The controller 21 controls the light emission timings of the light-emitting elements 5a and 5b in response to the rotation of the first scanning element 13 so that light Ra and Rb are each reflected in the same direction by the first scanning element 13.

Since the optical device 1 thus controls the emission timings of color light Ra and Rb depending on the scanning timing of the first scanning element 13, color light can be combined. This combining of light does not need a combining element such as a dichroic mirror, whereupon the optical system 3 can be miniaturized.

Since light emitted from the light-emitting elements 5a and 5b have their respective different wavelength peaks, it is possible to generate light of a different color from colors of light emitted from the light-emitting elements 5a and 5b.

The incident angle Gal of the red light Ra onto the first scanning element 13 is less than the incident angle Abl of the green light Rb.

The light-emitting element group 5 is the light-emitting element 5c, with the lens element 7 receiving the blue light Rc emitted from the light-emitting element 5c. Light Ra, Rb, and Rc exiting the lens element 7 are incident, at mutually different angles, on the first scanning element 13. The controller 21 controls the light emission of the light-emitting elements 5a, 5b, and 5c with their respective light emission timings shifted from each other. The light-emitting elements 5a, 5b, and 5c are arrayed such that the optical axes of the light-emitting elements 5a, 5b, and 5c are contained in the same plane PL1. The controller 21 controls the light emission timings of the first light-emitting element 5a, the second light-emitting element 5b, and the third light-emitting element 5c, in response to the rotation of the first scanning element 13, so that light Ra, Rb, and Rc are each reflected in the same direction by the first scanning element 13. Since the optical device 1 thus controls the emission timings of three color light Ra, Rb, and Rc depending on the scanning timing of the first scanning element 13, three color light can be combined. This combining of light does not need a combining element such as a dichroic mirror, whereupon the optical system 3 can be miniaturized.

Although this embodiment employs the combination of the vertical scanner as the first scanning element 13 and the horizontal scanner as the second scanning element 17, there may be employed a combination of the horizontal scanner as the first scanning element 13 and the vertical scanner as the second scanning element 17.

Although in this embodiment the prism 15 has the two reflection surfaces, i.e., the first reflection surface 15b and the second reflection surface 15c, it may have only the first reflection surface 15b or may have at least two or more reflection surfaces.

### Second Embodiment

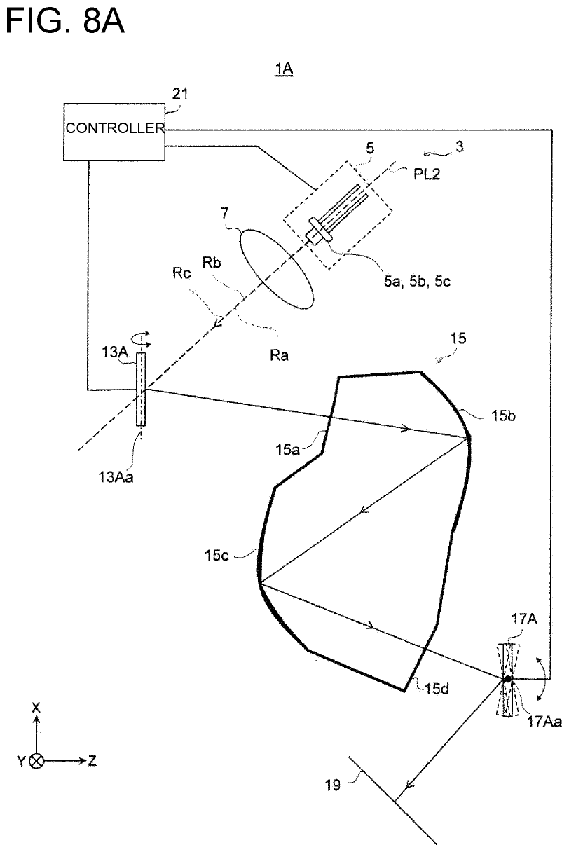

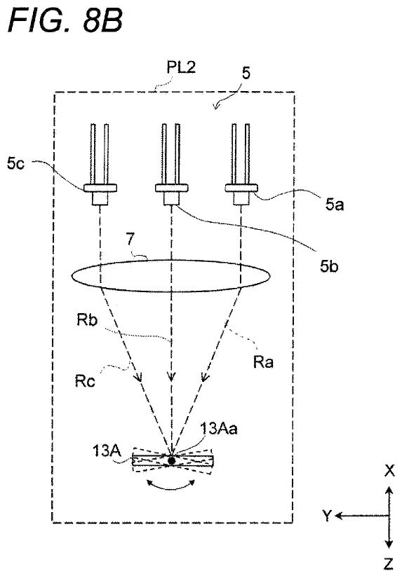

Referring next to FIGS. 8A and 8B, a second embodiment will be described. FIG. 8A is a sectional view showing a configuration of an optical device 1A in the second embodiment. FIG. 8B is an explanatory view showing an arrangement of the light-emitting elements 5a, 5b, and 5c.

In the first embodiment described above, the scanning axis 13a of the first scanning element 13 extends in Y-direction in FIG. 1, while the scanning axis 17a of the second scanning element 17 extends in X-direction in FIG. 1. In the second embodiment, as shown in FIG. 8A, a first scanning element 13A has a scanning axis extending in X-direction, while a second scanning element 17A has a scanning axis extending in Y-direction. In this case, a plane PL2 containing optical axes of light Ra, Rb, and Rc of the light-emitting elements 5a, 5b, and 5c, respectively, is a plane containing an axis in Y-direction. Except for this point and points described below, the optical device 1A of the second embodiment is the same in configuration as the optical device 1 of the first embodiment.

The first scanning element 13A rotates around a scanning axis 13Aa intersecting the plane PL2 and scans incident light within the plane PL2 in Y-direction. The first scanning element 13A is, for example, a mirror that is rotationally driven by piezoelectric drive with the rotation axis (scanning axis 13Aa) extending in X-direction. The first scanning element 13A is, for example, a horizontal scanner. This allows light reflected by the first scanning element 13A to diffuse in Y-direction. Since light incident on the first scanning element 13A from each of the light-emitting elements 5a to 5c has an incident angle with respect to X-direction, light incident on the first scanning element 13A is reflected in negative X-direction to impinge on the prism 15.

The light-emitting elements 5a, 5b, and 5c are arranged, for example, side by side in Y-direction. The light-emitting elements 5a, 5b, and 5c may be arranged offset in the front-rear direction with respect to the light emission direction as long as they lie within the plane PL2.

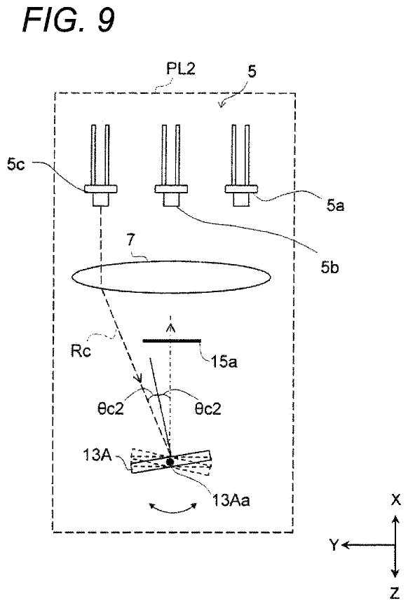

Referring then to FIGS. 9 to 11, description will be given of light-emitting actions of the light-emitting element group 5 and scanning of the first scanning element 13A, performed when correcting the incident angle onto the projection surface 19. FIGS. 9 to 11 are explanatory views showing the light emission timing of each of the light-emitting elements 5a, 5b, and 5c and the rotation action of the first scanning element 13A.

As shown in FIG. 9, for example, the light-emitting element 5c emits light at the timing of t3 so that the blue light Rc is incident at an incident angle θc2 on the first scanning element 13A and reflects thereon at a reflection angle θc2 to head for the incident surface 15a.

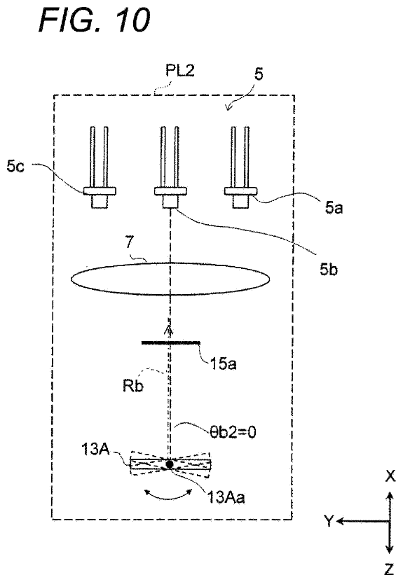

Next, as shown in FIG. 10, the first scanning element 13A rotates clockwise around the scanning axis 13Aa, and the light-emitting element 5b emits light at the timing of t4 so that the green light Rb is incident at an incident angle θb2 as the second incident angle on the first scanning element 13A and reflects thereon at a reflection angle θb2 to head for the incident surface 15a in the same direction as the direction of reflection of the blue light Rc. Since in the second embodiment the light-emitting element 5b is arranged on the center line of the lens element 7, the incident angle θb2 and the reflection angle θb2 are 0° in Y-direction.

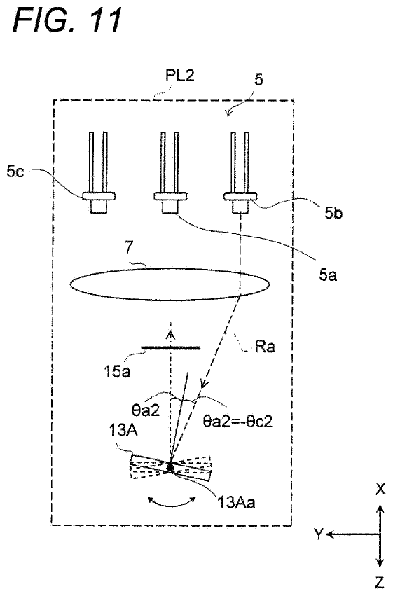

Next, as shown in FIG. 11, the first scanning element 13A further rotates clockwise around the scanning axis 13Aa, and the light-emitting element 5c emits light at the timing of t5 so that the red light Ra is incident at an incident angle θa2 on the first scanning element 13A and reflects thereon at a reflection angle θa2 to head for the incident surface 15a in the same direction as the direction of reflection of the blue light Rc and the green light Rb. In this manner, the blue light Rc, the green light Rb, and the red light Ra can be combined. The relationship between the incident angles θa2 and θc2 is ideally θa2=−θc2 in cases where, as shown in FIG. 8B, the light-emitting elements 5a and 5c are arranged symmetrically with respect to the center line of the lens element 7. For example, by keeping the shifts within 1′, projected light can be recognized as being combined when viewed by a person.

When the first scanning element 13 rotates counterclockwise, the red light Ra, the green light Rb, and the blue light Rc are sequentially emitted in the mentioned order, with the result that light can be combined.

In this manner, by shifting the light emission timings of the blue light-emitting element 5c and the red light-emitting element 5a with respect to the light emission timing of the green light-emitting element 5b so that their respective incident angles and reflected angles on the first scanning element 13 differ, light Ra, Rb, and Rc can reflect in the same direction, whereupon light Ra, Rb, and Rc can be combined.

### Other Embodiments

As above, the first and second embodiments have been described as exemplification of the techniques disclosed in the present application. However, the techniques in the present disclosure are not limited thereto, and are applicable to any embodiments undergoing alterations, permutations, additions, omissions, etc. It is also possible to combine the constituent elements described in the first and second embodiments into a new embodiment.

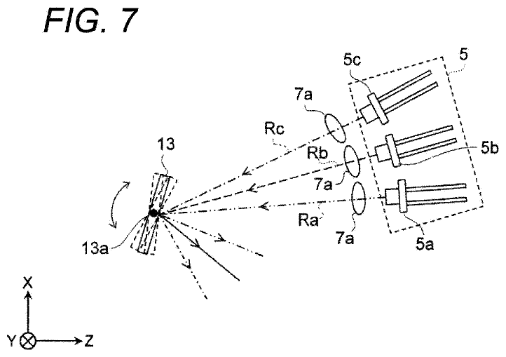

Although in the above embodiments one lens element 7 is arranged for the three light-emitting elements 5a, 5b, and 5c, this is not limitative. As shown in FIG. 7, the optical system 3 may include a plurality of lens elements 7a, with one lens element 7a arranged corresponding to one light-emitting element. The lens element 7a is, for example, a collimating lens.

Although in the above embodiments the light-emitting element group 5 includes the three light-emitting elements 5a, 5b, and 5c, it may include two or four or more light-emitting elements. For example, by allowing the light-emitting element group 5 to include two light-emitting elements (only the light-emitting elements 5a and 5b), the red light Ra and the green light Rb may be combined to generate a yellow light. The red, green, and blue light-emitting elements 5a, 5b, and 5c may be arranged at any positions. For example, in FIG. 3, the green light-emitting element may be replaced in position with the blue light-emitting element. The light-emitting element group 5 may include a plurality of light-emitting elements of the same color for the purpose of improving luminance. The light-emitting element group 5 may include a plurality of light-emitting elements of the same color (wavelength) having mutually different polarization axes for the purpose of controlling polarization characteristics.

Although in the above embodiments only the prism 15 is included in the relay optical system from the first scanning element 13 to the second scanning element 17, this is not limitative. The relay optical system may include an astigmatism correction element or a diopter correction element in addition to the prism 15.

As above, the embodiments have been described as exemplifications of the techniques in the present disclosure. To that end, the accompanying drawings and detailed description have been provided. Accordingly, the constituent elements described in the accompanying drawings and detailed description may include not only constituent elements essential for solving the problems but also constituent elements not essential for problem solving, for exemplifying the above techniques. Hence, those inessential constituent elements should not be construed as being essential immediately from the fact that those inessential constituent elements are described in the accompanying drawings or detailed description.

Since the above embodiments are intended to exemplify the techniques in the present disclosure, it is possible in claims or their equivalences to make various alterations, permutations, additions, omissions, etc.

### SUMMARY OF THE EMBODIMENTS

(1) The optical device of the present disclosure comprises: a light-emitting element group that includes a first light-emitting element and a second light-emitting element; a lens element that directs first light emitted from the first light-emitting element and second light emitted from the second light-emitting element, to a predetermined position; a first scanning element arranged at the predetermined position, on which first light and second light exiting the lens element are incident at mutually different angles; and a controller that controls light emission by differentiating light emission timings of the first light-emitting element and the second light-emitting element, the first light-emitting element and the second light-emitting element being arrayed such that an optical axis of first light and an optical axis of second light are contained in a same plane, the first scanning element having a scanning axis that extends in a direction orthogonal to the plane, the first scanning element rotating around the first scanning axis, the controller controlling the light emission timings of the first light-emitting element and the second light-emitting element in response to rotation of the first scanning element so that first light and second light are each reflected in a same direction by the first scanning element.

In this manner, due to no need for the combining element that combines first light and second light, the cost of the optical device can be reduced. Due to no inclusion of the combining element within the optical system, the optical system can be downsized.

(2) In the optical device of (1), first light and second light have their respective different colors. This enables generation of light of a color different from that of each of first light and second light.

(3) In the optical device of (1) or (2), first light and second light reflected in the same direction by the first scanning element are incident at a same position on a projection surface.

(4) In the optical device of any one of (1) to (3): the light-emitting element group includes a third light-emitting element; the lens element receives third light emitted from the third light-emitting element; the first scanning element receives, at mutually different angles, first light and second light that exit the lens element; the controller controls light emission by differentiating light emission timings of the first light-emitting element, the second light-emitting element, and the third light-emitting element; the first light-emitting element, the second light-emitting element, and the third light-emitting element are arrayed such that the optical axis of first light, the optical axis of second light, and the optical axis of third light are contained in a same plane; and the controller controls the light emission timings of the first light-emitting element, the second light-emitting element, and the third light-emitting element in response to rotation of the first scanning element so that first light, second light, and third light are each reflected in a same direction by the first scanning element.

(5) In the optical device of (4), first light, second light, and third light have their respective different colors. This enables generation of light of a color different from that of each of first light, second light, and third light, making it possible to increase the number of colors that can be generated.

(6) In the optical device of any one of (1) to (5), a relationship of

|arctan(Y/f)·180/π|<10°

is satisfied, where Y: length between first light and second light, and f: focal length of the lens element.

(7) In the optical device of (4) or (5): the second light-emitting element is arranged on a center line of the lens element between the first light-emitting element and the third light-emitting element; the first light-emitting element and the third light-emitting element are arranged symmetrically with respect to the center line of the lens element; and a relationship of

|θc−θb|=|θb−θa|

is satisfied, where θa: incident angle of the first light-emitting element on the first scanning element, θb: incident angle of the second light-emitting element on the first scanning element, and θc: incident angle of the third light-emitting element on the first scanning element.

(8) The optical device of any one of (1) to (7) comprises a second scanning element having a second scanning axis that extends in a direction orthogonal to the first scanning axis of the first scanning element.

(9) The optical device of (8) comprises a relay optical system arranged on an optical path from the first scanning element to the second scanning element, for collecting light scanned by the first scanning element onto the second scanning element.

(10) In the optical device of (9), the relay optical system comprises a prism having an incident surface, an exit surface, and one or more reflection surfaces.

The present disclosure is applicable to an optical device that combines a plurality of light.

What is claimed is:

1. An optical device comprising:
a light-emitting element group that includes a first light-emitting element and a second light-emitting element, each emitting light of a different color;
a lens element that directs first light emitted from the first light-emitting element and second light emitted from the second light-emitting element, to a predetermined position;
a first scanning element arranged at the predetermined position, on which first light and second light exiting the lens element are incident at mutually different angles, the first scanning element projecting a scannable area of first light in a scanning direction than a scannable area of second light; and
a controller that provides light emission control to start light emission at light emission timings shifted in order of the first light-emitting element and the second light-emitting element, to allow first light and second light to have a common drawing area,
the first light-emitting element and the second light-emitting element being arrayed such that an optical axis of first light and an optical axis of second light are contained in a same plane,
the first scanning element having a first scanning axis that extends in a direction orthogonal to the plane, the first scanning element acting rotationally around the first scanning axis,
the controller controlling the light emission timings of the first light-emitting element and the second light-emitting element in response to rotation actions of the first scanning element so that first light and second light are each reflected in a same direction by the first scanning element.

2. The optical device of claim 1, wherein
first light and second light reflected in the same direction by the first scanning element are incident at a same position on a projection surface.

3. The optical device of claim 1, wherein
the light-emitting element group includes a third light-emitting element that emits light of a color different from the colors of light emitted from the first light-emitting element and the second light-emitting element, wherein
the lens element receives third light emitted from the third light-emitting element, wherein
the first scanning element receives, at mutually different angles, first light, second light, and third light that exit the lens element, the first scanning element projecting the scannable area of second light to an area defined between the scannable area of first light and a scannable area of third light, wherein
the controller provides light emission control to start light emission at light emission timings shifted in order of the first light-emitting element, the second light-emitting element, and the third light-emitting element, to allow first light, second light, and third light to have a common drawing area, wherein
the first light-emitting element, the second light-emitting element, and the third light-emitting element are arrayed such that the optical axis of first light, the optical axis of second light, and the optical axis of third light are contained in a same plane, and wherein
the controller controls the light emission timings of the first light-emitting element, the second light-emitting element, and the third light-emitting element in response to rotation actions of the first scanning element so that first light, second light, and third light are each reflected in a same direction by the first scanning element.

4. The optical device of claim 1, wherein
a relationship of

|arctan(Y/f)·180/π|<10°
is satisfied,
where
Y: length between first light and second light, and
f: focal length of the lens element.

5. The optical device of claim 3, wherein
the second light-emitting element is arranged on a center line of the lens element between the first light-emitting element and the third light-emitting element, wherein
the first light-emitting element and the third light-emitting element are arranged symmetrically with respect to the center line of the lens element, and wherein
a relationship of

|θc−θb|=|θb−θa|

is satisfied,
where
θa: incident angle of the first light-emitting element on the first scanning element,
θb: incident angle of the second light-emitting element on the first scanning element, and
θc: incident angle of the third light-emitting element on the first scanning element.

6. The optical device of claim 1, comprising:
a second scanning element having a second scanning axis that extends in a direction orthogonal to the first scanning axis of the first scanning element, the second scanning element rotating around the second scanning axis to project, as a two-dimensional image, first light and second light projected from the first scanning element.

7. The optical device of claim 6, comprising:
a relay optical system arranged on an optical path from the first scanning element to the second scanning element, for collecting light scanned by the first scanning element onto the second scanning element.

8. The optical device of claim 7, wherein
the relay optical system comprises a prism having an incident surface, an exit surface, and one or more reflection surfaces.

9. The optical device of claim 2 wherein
a relationship of

|arctan(Y/f)·180/π|<10°
is satisfied,
where
Y: length between first light and second light, and
f: focal length of the lens element.

10. The optical device of claim 3 wherein
a relationship of

|arctan(Y/f)·180/π|<10°
is satisfied,
where
Y: length between first light and second light, and
f: focal length of the lens element.

11. The optical device of claim 2, comprising:
a second scanning element having a second scanning axis that extends in a direction orthogonal to the first scanning axis of the first scanning element, the second scanning element rotating around the second scanning axis to project, as a two-dimensional image, first light and second light projected from the first scanning element.

12. The optical device of claim 3, comprising:
a second scanning element having a second scanning axis that extends in a direction orthogonal to the first scanning axis of the first scanning element, the second scanning element rotating around the second scanning axis to project, as a two-dimensional image, first light, second light and third light projected from the first scanning element.

13. The optical device of claim 4, comprising:
a second scanning element having a second scanning axis that extends in a direction orthogonal to the first scanning axis of the first scanning element, the second scanning element rotating around the second scanning axis to project, as a two-dimensional image, first light and second light projected from the first scanning element.

14. The optical device of claim 5, comprising:
a second scanning element having a second scanning axis that extends in a direction orthogonal to the first scanning axis of the first scanning element, the second scanning element rotating around the second scanning axis to project, as a two-dimensional image, first light and second light projected from the first scanning element.
